(19) United States
(12) Patent Application Publication
(10) Pub. No.: US 2011/0081491 A1
(43) Pub. Date: Apr. 7, 2011

(54) METHOD AND SYSTEM FOR COLORING SEA SHELLS FOR USE AS GROUND COVER

(75) Inventors: Shawn Sundall, Naples, FL (US); Alan Krinsky, Naples, FL (US)

(73) Assignee: SHELL SCAPE OF FLORIDA, LLC, Fort Myers, FL (US)

(21) Appl. No.: 12/896,008

(22) Filed: Oct. 1, 2010

Related U.S. Application Data
(60) Provisional application No. 61/247,694, filed on Oct. 1, 2009.

(51) Int. Cl. B05D 3/00

(52) U.S. Cl. 427/322

(57) ABSTRACT

A method for coloring sea shells for use as mulch comprises receiving a quantity of shells; washing the shells to remove debris therefrom; segregating the shells to separate relatively larger shells for further processing; at least partially drying the shells; applying a coloring agent to the shells; and drying the colored shells.

### RELATED APPLICATIONS

This non-provisional patent application claims priority benefit with regard to all common subject matter of earlier filed U.S. Provisional Patent Application titled “Method and System for Coloring Sea Shells for Use as Ground Cover”, Ser. No. 61/247,694, filed on Oct. 1, 2009, which is hereby incorporated by reference in its entirety into the present application.

### FIELD OF INVENTION

The present invention relates to mulch and other ground cover.

### BACKGROUND

Mulch is often placed in gardens, landscaping, and around trees to retain moisture in soil, reduce erosion, and suppress weed growth and seed germination. A variety of materials have been used as mulch including organic materials such as wood chips, leaves, straw, shredded paper, and inorganic materials such as gravel, rocks, and recycled tires and plastic.

Unfortunately, conventional mulch materials suffer from limitations that limit their usefulness. For example, organic mulches decay quickly and therefore must be replaced or supplemented frequently. Organic mulches also mat down over time, forming a barrier that blocks water and air flow to the underlying soil. Inorganic mulches generally last longer than organic mulches and do not mat down as easily, but inorganic mulches do not provide nutrients to the underlying soil. Moreover, many people find inorganic mulches to be less attractive than organic mulches because of their relatively uniform piece size, color, and texture.

Accordingly, there is a need for an improved mulch that overcomes the limitations of the prior art.

### SUMMARY

Applicant has discovered that sea shells may be used as mulch and offer numerous advantages over conventional organic and inorganic mulch materials. For example, applicant has discovered that sea shells decay much more slowly than other organic mulches and therefore do not have to be replaced or supplemented as frequently. Sea shells also do not mat down as easily and are therefore more porous to air and water. Moreover, unlike inorganic mulch materials, sea shells provide valuable nutrients to the soil and are more randomly shaped and sized and are therefore more attractive to many people.

Applicant has also discovered that mulch made from sea shells is often more desirable when colored to complement the surrounding landscaping or gardening. However, because of their unique and non-uniform size, shape, and texture, sea shells are difficult to color with traditional methods without detracting from their natural beauty. For example, simply painting sea shells with traditional spray painting techniques completely covers the shells in color and destroys their natural and random appearance.

Applicant has discovered an improved method for coloring sea shells that allows any color or combination of colors to be applied without destroying the shells' natural appearance. One embodiment of the method broadly comprises the steps of receiving a quantity of shells; washing the shells to remove debris therefrom; segregating the shells to separate relatively larger shells for further processing; at least partially drying the larger shells; applying a coloring agent to the shells; and drying the colored shells.

The washing step may consist of several stages including a first double washing with a Powerscreen™ machine and a subsequent washing with an aggregate material washer. The segregating step may also consist of several stages performed with two or more shaker tables. The drying step may be performed at one or more stages and may be performed with one or more conveyors along which are mounted fans and/or heating elements. The coloring agent applying step is preferably performed in a screw conveyor along which is mounted a plurality of spray nozzles connected to sources of dye.

Another embodiment of the method broadly comprises the steps of receiving a quantity of shells; applying a primer mixture to the shells to create primed shells; drying the primed shells; applying a coloring agent to the primed shells to created colored shells; and then drying the colored shells.

The primer mixture may comprise approximately 5-15 cups of dye per ton of shells to be primed. The coloring agent may comprise approximately 1-5 gallons of dye and 1-10 gallons of water per ton of shells to be colored. Both the primer mixture and the coloring agents are applied to the shells in a cylinder mixer or by spray nozzles. The drying steps are performed with fans, heaters, and/or sunlight.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a block diagram illustrating certain steps and/or equipment of embodiments of the present invention.

FIG. 2 is another block diagram illustrating other steps and/or equipment of other embodiments of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

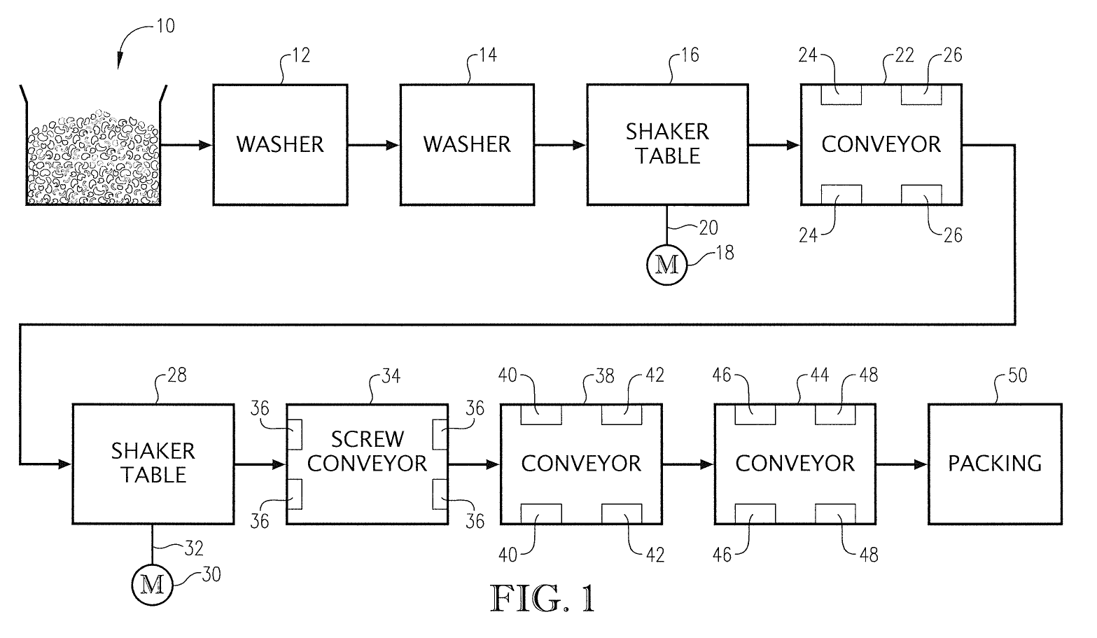

Turning now to the drawing figures, and particularly FIG. 1, a method for colorizing sea shells in accordance with a first embodiment of the invention is illustrated. The method may be performed with any suitable equipment that can achieve the objectives described herein. The claims of the application are not limited to any particular equipment unless specifically recited in the claims.

The method generally begins by obtaining a supply of sea shells 10. The sea shells are preferably retrieved from a mine or other excavated site or by any other manner that does not involve dredging an ocean floor. The shells may be of any shape or size but are typically ⅛″ to 2½″ in diameter. The shells may be delivered in bags, buckets, or by the truck load.

Sea shells obtained from mines or other excavated sites are typically embedded or coated with dirt, rock, and/or other debris and must be cleaned prior to coloring. Therefore, the next step in the method is to wash the sea shells in a washer 12. The washer 12 may be a Powerscreen™ machine provided by Powerscreen™ Crushing and Screening of Louisville, Kentucky or any equivalent or similar washer. The washer 12 may include a number of moveable screens and water spray jets that together segregate the shells from unwanted debris. The shells may be processed in the washer 12 any number of times until they are sufficiently cleaned, but are preferably washed twice. This step may be performed by a separate vendor before the shells are delivered to the site that colorizes them or may be performed as the initial step in the colorizing process.

The shells 10 are then delivered to a second washer 14 to clean them yet again. The second washer 14 is preferably an aggregate material washer having a number of spray jets. As with the first washing step performed with the washer 12, the second washing step may be performed anywhere, but is preferably performed at the site where the subsequent coloring steps are performed. Two separate washing steps are desirable because applicant has discovered that the shells must be virtually free of dirt and other debris to achieve optimal coloring.

The shells 10 are then delivered to a first shaker table 16. The first shaker table 16 includes a steel mesh floor with approximately ⅜″ openings and 2″-3″ upstanding sidewalls. The shaker table is coupled with an electric motor 18 by an offset pulley assembly 20. The motor 18 and pulley assembly 20 vibrate the shaker table 16 rather violently to shake water from the shells and to cause any shells that are smaller than ⅜″ in diameter to fall through the openings in the steel mesh floor. These smaller shells are not colored and may be sold as crushed shells or discarded. The first shaker table 16 is mounted at an approximately 25° down angle so that the shells are slowly gravity-fed off the end of the shaker table as they are shaken by the motor 18 and pulley assembly 20.

As the shells 10 drop off the end of the shaker table 16, they are received onto an approximately 10 ft. long conveyor 22. A number of heat lamps 24 and/or fans 26 are mounted along the length of the conveyor 22 to dry the shells as they travel along the conveyor. The heat lamps 24 and fans 26 may be operated at different levels and/or for different time intervals and/or the conveyor may be operated at any speed depending on how wet the shells are when they first enter the conveyor 22. For example, if the shells are essentially dry before they are first placed in the washer 14 because they have been exposed to lots of sun and/or heat after exiting the washer 12, the heat lamps 24 and fans 26 may be operated at a low level or cycled off for greater lengths of time and/or the conveyor may be operated at a high speed. Conversely, if the shells are completely saturated before they are placed in the washer 14, all of the heat lamps 24 and fans 26 may be operated at their highest levels and at a constant duty cycle and/or the conveyor may be operated at a slower speed.

The conveyor 22 then deposits the shells into a second shaker table 28. As with the first shaker table 16, the second shaker table 22 includes a steel mesh floor, but this floor has approximately ½″ openings to remove slightly larger shells. The shaker table 28 is also coupled with an electric motor 30 by an offset pulley assembly 32 to dry and segregate the shells as described above. The second shaker table 28 is also mounted at an approximately 25° down angle so that the shells are slowly gravity-fed off the end of the shaker table 28 as they are shaken by the motor 30 and pulley assembly 32.

As the shells drop off the end of the second shaker table 28, they are received at into the bottom of an approximately 9 ft. long, 12″ diameter vertical screw conveyor 34. The screw conveyor 34 lifts the shells as it turns and delivers them to an upper output. The screw conveyor 34 also includes a number of paddles that flip or otherwise agitate the shells as they pass from the bottom of the conveyor to the top.

A number of spray guns 36 coupled with air pressure paint pots or other dye-holding vessels are mounted along the length of the screw conveyor 34 for spraying liquid dye on the shells as they pass through the conveyor. Because the shells are periodically flipped or agitated as they pass through the screw conveyor 34, all sides of the shells are exposed to the dye applied by the spray guns 36.

The dye may be any color or combinations of color and may be mixed with any amount of water or other liquids. The dye may be an acid, basic, direct, disperse, reactive, sulfur, or vat type dye and may be water-soluble or water-insoluble. The dye may also be compounds that are not conventionally referred to as dyes such as paint, stain, or other colorants.

The shells that exit the screw conveyor 34 are completely saturated in liquid dye and therefore must be dried before packaging and/or transport. The shells are therefore deposited onto an approximately 5 ft. wide, 27 ft. long conveyor 38 along which is mounted several fans 40 and/or heaters 42. Again, the conveyor 38, the fans 40, and the heater 42 may be operated at any level or speed. This conveyor removes about 60% of the moisture from the shells.

The shells are then fed to an approximately 10 ft. long, 2 ft. wide covered conveyor 44 to remove additional moisture. The covered conveyor 44 that includes a number of heat lamps 46 and fans 48. The conveyor 44 is mounted at an approximately 45° up angle to elevate the shells for final packing. The heat lamps 46 and fans 48 may be operated at different levels and/or different frequencies and the conveyor may be operated at any selected speed depending on how wet the shells are when they first enter the conveyor 44.

The conveyor 44 then delivers the colored and dried shells to a final packing area 50 where the shells may be bagged for sale by a conventional bagging apparatus, dumped into the back of a truck, or otherwise processed for delivery to a customer or store. Prior to final packing, fertilizer, pesticides, and/or insecticides may be applied on or otherwise added to the shells.

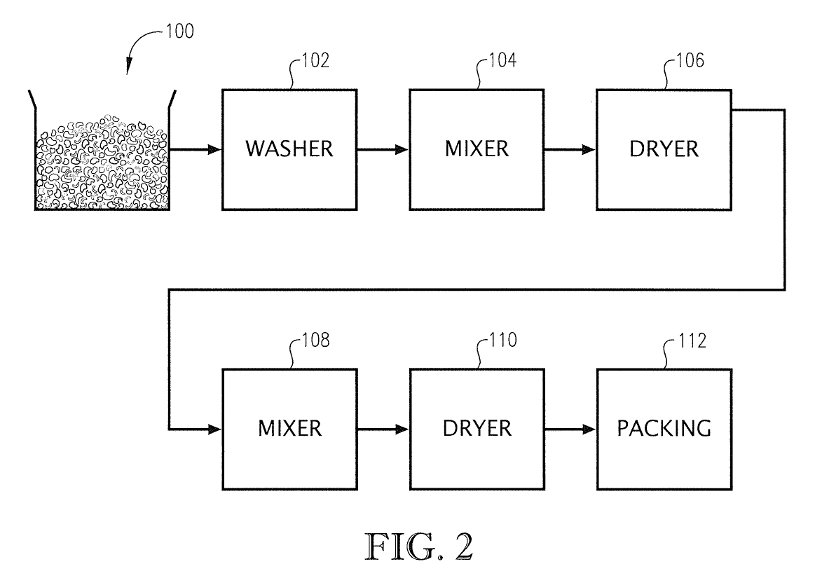

FIG. 2 illustrates a method for colorizing sea shells in accordance with an alternative embodiment of the invention. As with the first embodiment, the first step in the method is to obtain a supply of sea shells 100.

The shells 100 are then washed in a washer 102 to remove debris therefrom. The shells 100 may be washed in any conventional manner, including in the washers described in the first embodiment of the invention above.

The washed shells 100 are then placed into a cylinder mixer 104. Primer mixture is then added to the mixer, and the mixer is operated to coat the shells with the primer. The mixer may be operated at any speed and for any duration, and in one embodiment is operated at a speed of 1 revolution per second and for a duration of 1-10 minutes.

The primed shells are then removed from the mixer and dried in a dryer 106. The dryer may be similar to the drying conveyors described above.

Once the prime shells are dried, they are again placed into a cylinder mixer 108 along with a coloring agent. The mixer is again operated to coat the shells with the coloring agent. The mixer may be operated at any speed and for any duration, and in one embodiment is operated at a speed of 1 revolution per second and for a duration of 1-10 minutes.

The primer mixture may comprise approximately 5-15 cups of dye per ton of shells to be primed. The coloring agent may comprise approximately 1-5 gallons of dye and 1-10 gallons of water per ton of shells to be colored. Both the primer mixture and the coloring agents are applied to the shells in a cylinder mixer or by spray nozzles. The drying steps are performed with fans, heaters, and/or sunlight.

The shells are then removed from the mixer and dried in another dryer. After the shells are dried, they are transported to a packaging area 112 to be packaged for delivery to customers and/or stores. Prior to final packing, fertilizer, pesticides, and/or insecticides may be applied on or otherwise added to the shells.

Although the invention has been described with reference to the preferred embodiment illustrated in the attached drawing figures, it is noted that equivalents may be employed and substitutions made herein without departing from the scope of the invention as recited in the claims. For example, the particular equipment described and illustrated herein may be replaced with similar equipment without departing from the scope of the claims.

Having thus described the preferred embodiment of the invention, what is claimed as new and desired to be protected by Letters Patent includes the following:

1. A method of creating mulch comprising the steps:
receiving a quantity of shells;
washing the shells to remove debris therefrom;
at least partially drying the shells;
applying a coloring agent to the shells; and
drying the colored shells.

2. The method as set forth in claim 1, wherein the washing step is performed with an aggregate material washer.

3. The method as set forth in claim 1, wherein the segregating step is performed with two shaker tables.

4. The method as set forth in claim 1, wherein the drying step is performed with one or more conveyors along which are mounted fans and/or heating elements.

5. The method as set forth in claim 1, wherein the coloring agent is applied in a screw conveyor.

6. The method as set forth in claim 1, further comprising the step of segregating the shells while washing them to separate relatively larger shells for further processing.

7. A method of creating mulch comprising the steps:
receiving a quantity of shells;
applying a primer mixture to the shells to create primed shells;
drying the primed shells;
applying a coloring agent to the primed shells to created colored shells; and
drying the colored shells.

8. The method as set forth in claim 7, wherein the primer mixture comprises approximately 5-15 cups of dye per ton of shells to be primed.

9. The method as set forth in claim 7, wherein the coloring agent comprises approximately 1-5 gallons of dye and 1-10 gallons of water per ton of shells to be colored.

10. The method as set forth in claim 7, wherein the primer mixture is applied to the shells in a cylinder mixer.

11. The method as set forth in claim 7, wherein the coloring agent is applied to the shells in a cylinder mixer.

12. The method as set forth in claim 7, wherein the primer mixture is applied to the shells by spray nozzles.

13. The method as set forth in claim 7, wherein the coloring agent is applied to the shells by spray nozzles.

14. The method as set forth in claim 7, wherein the drying steps are performed with fans, heaters, and/or sunlight.

15. A method of creating mulch from sea shells, the method comprising the steps:
receiving a quantity of sea shells;
washing the sea shells to remove debris therefrom;
placing the washed sea shells into a mixer;
adding a primer mixture to the mixer;
operating the mixer to coat the sea shells with the primer mixture to create primed sea shells;
removing the primed sea shells from the mixer;
drying the primed sea shells;
placing the primed sea shells into a mixer;
adding a coloring agent to the mixer;
operating the mixer to coat the primed sea shells with the coloring agent to create colored sea shells;
drying the colored sea shells; and
packaging the colored sea shells for delivery to customers.

16. The method as set forth in claim 15, wherein the primer mixture comprises approximately 5-15 cups of dye per ton of sea shells to be primed.

17. The method as set forth in claim 15, wherein the coloring agent comprises approximately 1-5 gallons of dye and 1-10 gallons of water per ton of sea shells to be colored.

18. The method as set forth in claim 15, wherein the drying steps are performed with fans, heaters, and/or sunlight.
